(19) United States
(12) Patent Application Publication
(10) Pub. No.: US 2008/0137909 A1
(43) Pub. Date: Jun. 12, 2008

(54) METHOD AND APPARATUS FOR TRACKING GAZE POSITION

(75) Inventors: Jaeseon LEE, Seoul (KR); Young Giu JUNG, Dajeon (KR); Mun Sung HAN, Daejeon (KR); Jun Seok PARK, Daejeon (KR); Eui Chul LEE, Seoul (KR); Kang Ryoung PARK, Seoul (KR); Min Cheol HWANG, Kyungki-Do (KR); Joa Sang LIM, Kyungki-Do (KR); Yongjoo CHO, Seoul (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 11/951,813

(22) Filed: Dec. 6, 2007

(30) Foreign Application Priority Data
Dec. 6, 2006 (KR) 10-2006-0123178

(51) Int. Cl. G06K 9/00

(52) U.S. Cl. 382/103

(57) ABSTRACT

A gaze position tracking method and apparatus for simply mapping one's gaze position on a monitor screen are provided. The gaze position tracking apparatus includes an image capturing module, and an image processing module. The image capturing module illuminates infrared rays to a user's eyes, reflects an illuminated eye image at 45°, and captures the 45° reflected eye image. The image processing module obtains a pupil center point of the illuminated eye image by performing a predetermined algorithm, and maps the pupil center point on a display plane of a display device through a predetermined transform function.

### CLAIM OF PRIORITY

This application claims the benefit of Korean Patent Application No. 10-2006-123178 filed on Dec. 6, 2006 in the Korean Intellectual Property Office, the disclosure of which is incorporated herein by reference.

### BACKGROUND OF THE INVENTION

1. Field of the Invention

The present invention relates to a method and an apparatus for tracking gaze position and, more particularly, to a gaze position tracking method and apparatus for simply mapping one's gaze position on a monitor screen.

This work was supported by the IT R&D program of MIC/IITA [2006-S-031-01, Five Senses Information Processing Technology Development for Network Based Reality Service].

2. Description of the Related Art

Gaze position tracking is a method for tracking a position of a monitor screen where a user gazes.

The gaze position tracking can be applied to point out a user' gaze position on a computer monitor as like as a protocol for driving a typical mouse. That is, the gaze position tracking can be used as an input device for a handicapped person who is unable to use hands. The gaze position tracking can be also applied to a virtual reality field to provide high immersion to a user.

The gaze position tracking is generally divided into a skin electrodes based gaze detection method, a contact lens based gaze detection method, a head mounted display based gaze detection method, a remote Pan&Tilt device based gaze detection method.

In the skin electrode based gaze position tracking method, electrodes are disposed around a user's eyes and measures potential differences between a retina and a cornea, and a gaze position is calculated through the measured potential difference. The skin electrode based method has advantages of detecting the gaze positions of both eyes, low cost, and a simple way of using.

The skin electrode based gaze position tracking method, however, has shortcoming of less accuracy because movements in a horizontal and vertical direction is limited.

In the contact lens based gaze position tracking method, a non-slippery lens is worn on a cornea, a magnetic field coil or a mirror is attached thereon, and a gaze position is calculated. Although the accuracy of detecting the gaze position is very high, the contact lens with the magnetic field coil or the mirror makes a user uncomfortable. Furthermore, a range of calculating the gaze position is limited.

In the head mounted display based gaze position tracking method, the head mounted display is a display device mounted on glasses or a helmet, which a person wears on the head to have video information directly displayed in front of the eyes. In the head mounted display, two small display devices are disposed in front of both eyes, and stereo-scopic images are displayed thereon, thereby enabling a user to experience three-dimensional space. The head-mounted display was developed by U.S. air force for a military purpose. Recently, the head-mounted display is generally applied to various virtual realty fields, such as three-dimensional images, games, and medical fields. The head-mounted display can be used as a monitor of medical equipment used in diagnosis, treatment, and a surgical operation, or a simulation equipment for various educational fields.

The head mounted display based gaze position tracking method is a method for detecting a user's gaze position through the head mounted display. That is, the gaze position is calculated by mounting a small camera at a hair band or a helmet. Therefore, the head mounted display based gaze position tracking method has an advantage of calculating the gaze position regardless the head movement of the user. The head mounted display based gaze position tracking method, however, is not sensitive to the up and down movement of eyes because the cameras are inclined toward the bottom of a user's eye-level.

In the remote Pan&Tilt device based gaze position tracking method, the gaze position is calculated by disposing pan and tilting cameras and lightings around a monitor. This method can quickly and accurately calculate the gaze position. Also, it is easy to apply the remote Pan&Tilt device. However, it requires at least two of high cost stereo cameras to track the movement of the head, complicated algorithm, and complex calibration between the cameras and the monitor.

As described above, if the conventional gaze position tracking methods have the advantages of low cost and simple way of using, the accuracy thereof is low. If the conventional gaze position tracking method provides the high accuracy using high cost equipment such as stereo cameras and Pan&Tilt device, it cannot be applied to a low cost system due to large volume and weight, high cost, and complicated numerous image processing steps.

Furthermore, the conventional gaze position tracking methods are not sensitive to the up and down movement of the pupil because the cameras are disposed under the eye-level of the user not to block the eye-level. Moreover, a conventional gaze position tracking apparatus is not compatible to other environments because the conventional gaze position tracking apparatus is generally designed to be belonged to one terminal.

### SUMMARY OF THE INVENTION

The present invention has been made to solve the foregoing problems of the prior art and therefore an aspect of the present invention is to provide a gaze position tracking method for enabling a gaze position tracking apparatus to accurately track a gaze position on a terminal having a display device using small and low cost equipment, and an apparatus thereof.

Another aspect of the present invention to provide a gaze position tracking method for enabling a gaze position tracking apparatus for tracking a user's gaze position on a terminal having a display device to sensitively response to the up-down movement of the user's pupil, and an apparatus thereof.

Further another aspect of the present invention to provide a gaze position tracking method for enabling a gaze position tracking apparatus for tracking a user's gaze position on a terminal having a display device to have compatibility to various environments by performing a simple image processing algorithm, and an apparatus thereof.

According to an aspect of the invention, the invention provides a gaze detection apparatus for detecting a user's gaze position form a terminal having a display device, including an image capturing module and an image processing module. The image capturing module illuminates infrared rays to a user's eyes, reflects an eye image illuminated by infrared rays (hereinafter, infrared eye image) at 45°, and captures the 45° reflected eye image. The image processing module obtains a pupil center point of the infrared eye image by performing a predetermined algorithm, and maps the pupil center point on a display plane of a display device through a predetermined transform function.

The image capturing module may include: an infrared ray lighting unit for illuminating an infrared ray to the user's eyes; an infrared ray reflector for reflecting the infrared eye image at 45°; and a miniature camera for capturing the 45° reflected eye image.

The infrared ray lighting unit may include at least one of LED (light emitting diode), a halogen lamp, a xenon lamp, and an incandescent electric lamp.

The miniature camera may include: a lens for receiving the 45° reflected eye image through the infrared reflector; an image sensor formed of charge coupled device (CCD) or complementary metal-oxide semiconductor (CMOS) for receiving the eye image inputted to the lens; and an infrared ray pass filter mounted on the entire surface of the lens or the image sensor for passing a infrared ray wavelength only.

The image capturing module may be mounted at least one of glasses, goggles, a helmet, and a fixable supporting member.

The image capturing module may be embodied in the terminal in software manner.

The image capturing module may further include an interface unit connected to the terminal in a PnP (plug and play) manner, supplies power provided from the terminal to the infrared ray lighting unit and the miniature camera, and providing every image frame captured through the miniature camera to the terminal.

The interface unit may be connected to the terminal in at least one of a USB (universal serial bus) type, an analog type, a SD (secure digital) type, and a CD (compact disc) type.

The image processing module may obtain the pupil center point by performing at least one of a circle detection algorithm and a local binarization scheme, wherein the circle detection algorithm detects a pupil region by shifting a circle template to the eye image and obtains the pupil center point from the detected pupil region and the local binarization scheme performs binarization on predetermined region from the pupil region and detects the center of gravity of a dark region as the pupil center point.

The transform function may be a linear interpolation transform function, a geometric transform function, and a cross ration transform function.

The image processing module may calibrate a display plane position corresponding to a user pupil center point by performing a user calibration process, and performs a mapping process on the display plane for the every captured eye image.

The image processing module may perform the user calibration process by calibrating the display plane position from an image of eyes gazing at a right upper corner and a left lower corner or from an images of eyes gazing at a right lower corner and a left upper corner using linear the interpolation transform function, or by calibrating the display plane position from images of eyes gazing at four corners of the display plane using the geometric transform function and the cross ration transform function.

According to another aspect of the invention for realizing the object, there is provided a gaze position tracking method for tracking a user's gaze position for a terminal having a display device. In the gaze position tracking method, an infrared ray is illuminated to a user's eyes gazing a display plane of the display device. An eye image illuminated by infrared rays (hereinafter, infrared eye image) is reflected at 45° and a 45° reflected eye image is captured. A pupil center point of the eye image is detected by performing the predetermined algorithm, and the pupil center point is mapped to the display plane using the predetermined transform function.

In the step of illuminating the infrared ray, the user's eyes maybe illuminated using at least one of LED (light emitting diode), a halogen lamp, a xenon lamp, and an incandescent electric lamp.

The 45° reflected infrared eye image is only passed by mounting an infrared ray passing filter on the entire surface of the miniature camera lens or an image sensor.

In the step of capturing the 45° reflected eye image, the user's eye image may be captured a miniature camera mounted on at least one of glasses, goggles, a helmet, and a supporting member, an infrared ray lighting unit, and an infrared ray reflector.

In the step of obtaining the pupil center point, the eye image may be captured through the miniature camera to the terminal in a PnP manner, and the pupil center point may be obtained through the predetermined algorithm.

In the step of providing the eye image to a terminal in the PnP manner, the eye image may be provided to the terminal in at least one of a USB type, an analog type, a SD type, and a CD type.

The step of obtaining the pupil center point may include: obtaining the pupil center point by performing at least one of a circle detection algorithm and a local binarization scheme, wherein the circle detection algorithm detects a pupil region by shifting a circle template to the eye image and obtains the pupil center point from the detected pupil region and the local binarization scheme performs binarization on predetermined region from the pupil region and detects the center of gravity of a dark region as the pupil center point.

In the step for mapping the pupil center point on a display plane, the pupil center point may be mapped to the display plane through one of a linear interpolation transform function, a geometric transform function, and a cross ration transform function.

The gaze detection method may further include a step of calibrating a display plane position corresponding a user pupil center point by performing a user calibration process in a system initialization period.

In the step of calibrating the display plane position corresponding the user pupil center point, the display plane position may be calibrated from an image of eyes gazing at a right upper corner and a left lower corner or from an images of eyes gazing at a right lower corner and a left upper corner using linear the interpolation transform function, or the display plane position may be calibrated from images of eyes gazing at four corners of the display plane using the geometric transform function and the cross ration transform function.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a gaze position tracking apparatus according to an embodiment of the present invention;

FIG. 2A is a diagram illustrating a method of performing a circle detection algorithm according to an embodiment of the present invention;

FIG. 2B is a diagram illustrating a local binarization scheme to obtain a pupil center point according to an embodiment of the present invention;

FIG. 3 is a diagram illustrating a user calibration process with a linear interpolation transform function according to an embodiment of the present invention;

FIG. 4 is a diagram illustrating a user calibration process with a geometric transform function according to an embodiment of the present invention;

FIG. 5 is a diagram illustrating a user calibration process with a cross ration transform function according to an embodiment of the present invention; and

FIG. 6 is a flowchart illustrating a gaze position tracking method of a gaze position tracking apparatus according to an embodiment of the present invention.

### DETAILED DESCRIPTION OF THE PREFERRED EMBODIMENT

Certain embodiments of the present invention will now be described in detail with reference to the accompanying drawings. In order to clearly show the features of the present invention, descriptions of well-known functions and structures will be omitted.

Like numeral references denote like elements throughout the accompanying drawings.

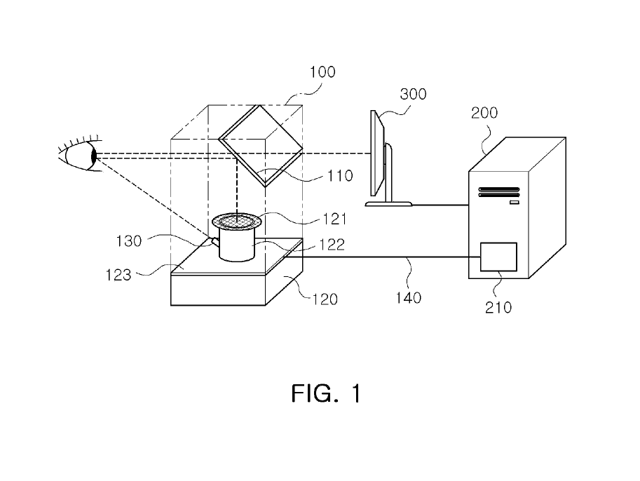

FIG. 1 is a block diagram illustrating a gaze position tracking apparatus according to an embodiment of the present invention.

Referring to FIG. 1, the gaze position tracking apparatus according to an embodiment of the present invention includes an image capturing module 100 mounted at glasses, a helmet, and a fixable supporting member for capturing an image of a user's eyes (hereinafter, eye image), and an image processing module 210 for detecting a gaze position on a display device 300 such as a monitor based on the eye image captured from the image capturing module 100.

The image capturing module 100 includes an infrared ray lighting unit 110, an infrared ray reflector 120, a miniature camera 130, and an interface unit 140. The image capturing module 100 provides images of a user's eyes moving according to the gaze on a monitor, made by a user.

In the image capturing module 100, an infrared ray lighting unit 110 includes an infrared ray light emitting diodes (LED), halogen lamps, xenon lamps, and incandescent electric lamps for radiating infrared rays to the user's eyes.

The infrared ray reflector 120 may include a hot mirror titled at 45° from a user's eye-level to reflect the eye image illuminated by infrared rays (hereinafter, infrared eye image) to the miniature camera 130 with 45°. The infrared ray reflector 120 is titled at 45° to increase a resolution of the top to down movement of eyes in the eye image inputted to the miniature camera 130.

The miniature camera 130 includes an infrared ray pass filter 131, a lens 132, and an image sensor 133. The infrared ray pass filter 131 is attached on entire surface of the lens 132 or the image sensor 133 to capture an infrared eye image only through the lens 132 or the image sensor 133. In FIG. 1, the infrared ray pass filter 131 is coated on the entire surface of the lens 132.

The image sensor 133 may be formed of charge coupled device (CCD) or complementary-metal-oxide semiconductor (CMOS).

The interface unit 140 transmits every frame of images captured from the miniature camera 130 to the terminal 200, and supplies power from the terminal 200 to the miniature camera 130 and the infrared ray lighting unit 110. Herein, the interface unit 140 may be a universal serial bus (USB) type, an analog type, a secure digital (SD) type, or a compact disc (CD) type.

The image capture module 100 drives the infrared ray lighting unit 110 using power supplied from the interface unit 140 and control the infrared ray lighting unit 110 to illuminate a user's eye with constant brightness. Also, the image capture module 100 uses the infrared reflector 120 for reflecting the infrared rays only and the infrared ray pass filter 131 for passing the infrared ray only to capture an infrared image of eyes, which clearly shows the boundary of the pupil and the iris, without being influenced by a peripheral external light.

The image processing module 210 is included in the terminal 200. The image processing module 210 is embodied as software and obtains a center point of a user's pupil by performing an image processing algorithm on the image frames provided from the image capturing module 100. The image processing modules 210 displays the obtained center point of the pupil on the monitor 300 as a gaze position of a user.

That is, the image processing module 210 receives the eye image, detects a user's pupil region from the corresponding eye image by performing a circle detection algorithm with image processing algorithm, and detects a center point of the pupil from the detected pupil region. The image processing module 210 maps the obtained center point of the pupil on the monitor 300 through predetermined transform functions, thereby displaying the gaze position on the monitor 300 as a pointer.

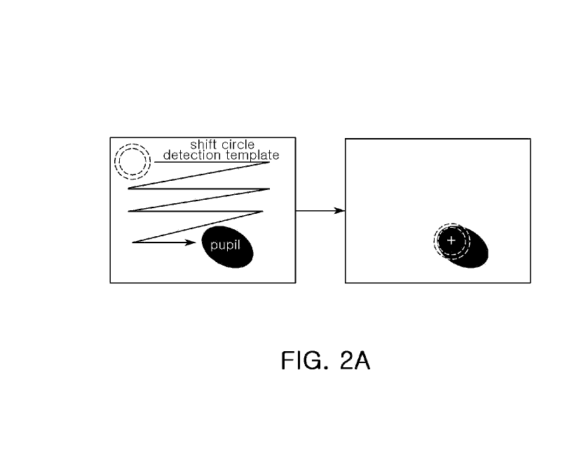

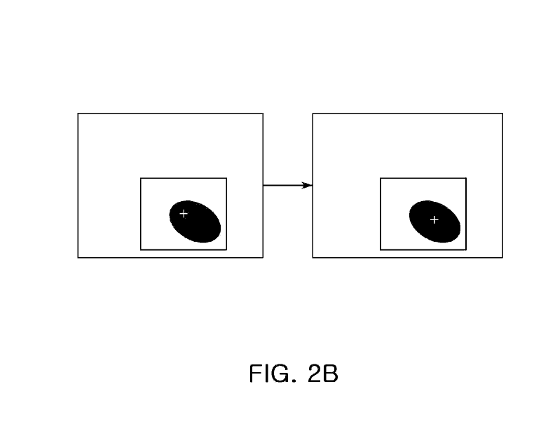

The image processing module 210 uses the circle detection algorithm as shown in FIG. 2A to obtain the pupil center point through the image processing algorithm.

FIG. 2A is a diagram illustrating a method of performing a circle detection algorithm according to an embodiment of the present invention.

Referring to FIG. 2A, in the circle detection algorithm, a circle detection template formed of an inner circle and an outer circle moves to the eye image. Then, a pupil region having the greatest gray level difference between the inner circle and the outer circle of the template is detected, and the center of the detected pupil region is obtained as the center point of the pupil (hereinafter, initial pupil center point).

Since the shape of pupil is oval, the image processing module 210 may further perform a local binarization scheme as shown in FIG. 2B with the circle detection algorithm when a user gazes a corner of the monitor 300.

FIG. 2B is a diagram illustrating a local binarization scheme to obtain a pupil center point according to an embodiment of the present invention.

Referring to FIG. 2B, the image processing module 210 performs a local binarization scheme on regions defined within a predetermined distance from the initial pupil center point obtained through the circle detection algorithm, calculates a center of gravity of a dark region among the binarized regions, and obtains the corresponding center of gravity as a real center point of a user's pupil.

The image processing module 210 performs the circle detection algorithm with the local binarization scheme in order to accurately detect the center point of the pupil. That is, region of from the initial pupil center point the dark region among the binarized regions is determined as the pupil region, and the center of gravity of the dark region is detected as the actual center point of the pupil.

The image processing module 210 may perform the circle detection algorithm only, or sequentially perform the circle detection algorithm and the local binarization scheme. Also, the image processing module 210 performs only the local binary scheme to obtain the center point of the pupil.

The image processing module 210 maps the center point of the obtained pupil on plane of the monitor 300 through the predetermined transform functions. Accordingly user's gaze position is mapped on the monitor 300.

The predetermined transform function may be at least one of a linear interpolation transform function, a geometric transform function, and a cross ration transform function, which are used in a user calibration process at a system initial period.

Hereinafter, the user calibration process performed in a system initial period will be described.

The gaze position tracking apparatus performs a mapping process for every image frames after calibrating the positions of a monitor 300 corresponding to the pupil center pint by performing a user calibration process at a system initial period.

In the present embodiment, the user calibration process is performed using various transform functions such as a linear interpolation transform function, a geometric transform function, or a cross ration transform function.

That is, the gaze position tracking apparatus may perform one of a two-stage calibration process or a four-stage calibration process. In the two-stage calibration process, the image processing module 210 performs the linear interpolation transform function while asking a user to gaze at a right upper corner and a left lower corner, or while asking a user to gaze at a left upper corner and a right lower corner. In the four-stage calibration process, the image processing module 210 performs the geometric transform function or the cross ration transform function while asking a user to gaze at four corners of the monitor 300.

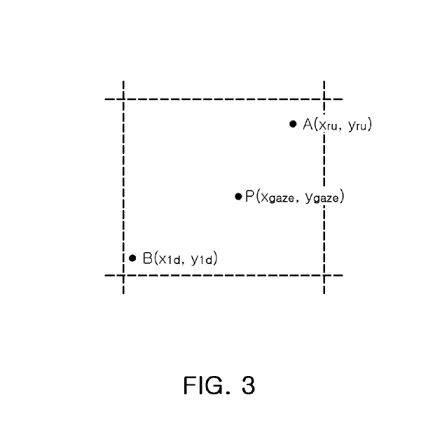

FIG. 3 is a diagram illustrating a user calibration process with a linear interpolation transform function according to an embodiment of the present invention.

Referring to FIG. 3, the image processing module 210 is sequentially provided with an image of a user's eyes gazing a right upper corner, an image of user's eye gazing a left lower corner, and an image of user's eye gazing a predetermined position of a monitor 300 at a system initialization period. Then, the image processing module 210 obtains a center point of a pupil, a pupil center coordinate (A, B), corresponding to each of the provided eye images through the image processing algorithm and the circle detection algorithm. Then, the image processing module 210 calculates a monitor plane position P corresponding to the pupil center point of the eye gazing the predetermined position of the monitor 300 using the linear interpolation transform function of Eq. 1.

$${x}_{gaze} = \frac{{Resol}_{x} \cdot ( {x}_{rec} - {x}_{ru} )}{( {x}_{ld} - {x}_{ru} )} \\ {y}_{gaze} = \frac{{Resol}_{y} \cdot ( {y}_{rec} - {y}_{ru} )}{( {y}_{ld} - {y}_{ru} )} \qquad Eq . 1$$

In Eq. 1, (x_{gaze}, y_{gaze}) denotes a monitor plane position, (Resolₓ, Resol_{y}) denotes a vertical and horizontal monitor resolution, and (x_{rec}, y_{rec}) denotes a pupil center point coordinate of an eye gazing a predetermined position of a monitor. (xᵣᵤ, yᵣᵤ) denotes a pupil center point coordinate of an eye gazing a right upper corner of a monitor, and (x_{1d}, y_{1d}) denotes a pupil center point coordinate of an eye gazing a left lower corner of a monitor.

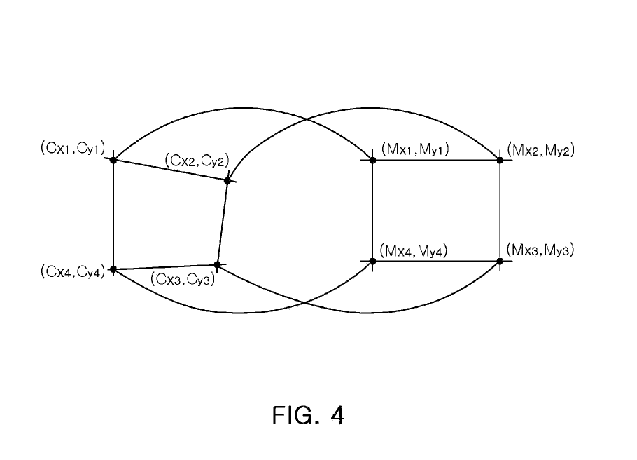

FIG. 4 is a diagram illustrating a user calibration process with a geometric transform function according to an embodiment of the present invention.

Referring to FIG. 4, the image processing module 210 is sequentially provided with images of user's eye gazing a right upper corner, a right lower corner, a left lower corner, and a left upper corner of a monitor 300 at a system initialization period. Then, the image processing module 210 calculates a pupil center coordinate corresponding to each of the provided eye images through the image processing algorithm and the circle detection algorithm. Then, the image processing module 210 calculates monitor plane positions corresponding to each of the calculated pupil center points using geometric transform function of Eq. 2.

mₓ₁=aCₓ₁+bC_{y1}+cCₓ₁C_{y1}+d

m_{y1}=eCₓ₁+fC_{y1}+gCₓ₁C_{y1}+h

mₓ₂=aCₓ₂+bC_{y2}+cCₓ₂C_{y2}+d

m_{y2}=eCₓ₂+fC_{y2}+gCₓ₂C_{y2}+h

mₓ₃=aCₓ₃+bC_{y3}+cCₓ₃C_{y3}+d

m_{y3}=eCₓ₃+fC_{y3}+gCₓ₃C_{y3}+h

mₓ₄=aCₓ₄+bC_{y4}+cCₓ₄C_{y4}+d

m_{y4}=eCₓ₄+fC_{y4}+gCₓ₄C_{y4}+h Eq. 2

In Eq. 2, (Cₓ₁, C_{y1})˜(Cₓ₄, C_{y4}) denote pupil center point coordinates of eye gazing four corners of a monitor, and (mₘ₁, m_{y1})˜(mₓ₄, m_{y4}) denote monitor plane positions.

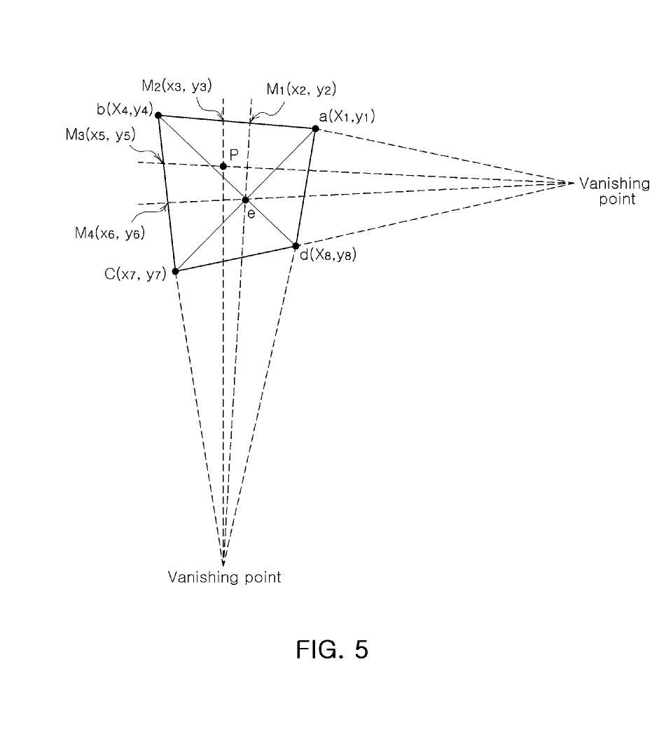

FIG. 5 is a diagram illustrating a user calibration process with a cross ration transform function according to an embodiment of the present invention.

Referring to FIG. 5, the image processing module 210 is sequentially provided with images of eyes gazing a right upper corner, a left upper corner, a left lower corner, and a right lower corner, and an image of eyes gazing a predetermined position P of a monitor 300 at a system initial period. The image processing module 210 obtains pupil center coordinates (a, b, c, d), a vanishing point, points (M1 to M4) meeting the vanishing point by performing the image processing algorithm and the circle detection algorithm. Then, the image processing module 210 calculates a monitor plane position corresponding to a pupil center point of eyes gazing a predetermined position of the monitor 300 using the cross ration transform function of Eq. 3.

$${CR}_{x} = \frac{( {x}_{4} {y}_{2} - {x}_{2} {y}_{4} ) ( {x}_{3} {y}_{4} - {x}_{4} {y}_{3} )}{( {x}_{1} {y}_{5} - {x}_{3} {y}_{1} ) ( {x}_{1} {y}_{2} - {x}_{2} {y}_{1} )} \\ {CR}_{y} = \frac{( {x}_{4} {y}_{6} - {x}_{6} {y}_{4} ) ( {x}_{5} {y}_{4} - {x}_{4} {y}_{5} )}{( {x}_{7} {y}_{5} - {x}_{5} {y}_{7} ) ( {x}_{6} {y}_{7} - {x}_{7} {y}_{6} )} \\ {CR}_{x} = \frac{( w - \frac{w}{2} ) {X}_{gaze}}{( w - {X}_{gaze} ) \frac{w}{2}} = \frac{{X}_{gaze}}{w - {X}_{gaze}} \\ {CR}_{y} = \frac{( h - \frac{h}{2} ) {Y}_{gaze}}{( h - {Y}_{gaze} ) \frac{h}{2}} = \frac{{Y}_{gaze}}{h - {Y}_{gaze}} \\ {X}_{gaze} = \frac{w \cdot {CR}_{x}}{1 + {CR}_{x}} \\ {Y}_{gaze} = \frac{h \cdot {CR}_{y}}{1 + {CR}_{y}} \qquad Eq . 3$$

In Eq. 3, a, b, c, and d denotes pupil center coordinates of a user's eyes gazing four corners of a monitor, P denotes a pupil center coordinate of user's eyes gazing a predetermined position of a monitor, (x_{gaze}, y_{gaze}) denotes a monitor plane position corresponding to P, (w, h) denotes a vertical space resolution and a horizontal space resolution of a monitor, and (CRₓ, CR_{y}) denotes a Cross ration.

As described above, the image processing module 210 calibrates a monitor 300 plane position calculated corresponding to the user pupil center point through the linear interpolation, the geometric transform, and the cross transform. Then, the image processing module 210 performs a monitor plane mapping process for every image frames provided from the image capturing module 100.

As described above, the gaze position tracking apparatus according to the present embodiment includes the image capturing module 100 constituted of low cost miniature cameras 130 and small devices for capturing the eye images. The image capturing module 100 is connected to the terminal 200 through one of a USB type interface, a SD type interface, or a CD type interface in a plug and play (PnP) manner. The gaze position tracking apparatus according to the present embodiment also includes the image processing module 210 embodied as software for detecting a pupil center point of every image frame provided from the image capturing module 100 and mapping the pupil center point to the monitor 300 plane. Therefore, the gaze position tracking apparatus according to the present embodiment is not limited to one environment to detect the user's gaze position but can be used for all terminals 200 that can recognize the image processing module 210.

The gaze position tracking apparatus supports a PnP function and has compatibility to all environments that can recognize the image processing module 210.

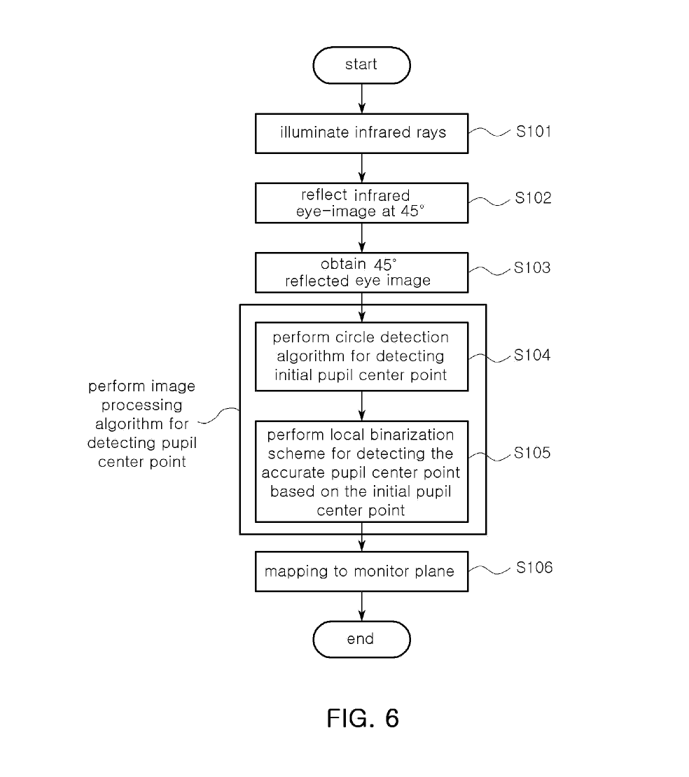

FIG. 6 is a flowchart illustrating a gaze position tracking method of a gaze position tracking apparatus according to an embodiment of the present invention.

It assumes that the user calibration process is already performed at the system initial period. Therefore, the description of the user calibration process is omitted herein.

Referring to FIG. 6, at step S101, the gaze position tracking apparatus illuminates the infrared rays to the user's eyes using power provided from the terminal 200.

Then, the gaze position tracking apparatus obtains a corresponding eye image at step S103 by reflecting the infrared image of user's eyes at 45° to the miniature camera 130 at step S102.

The gaze position tracking apparatus performs the image processing algorithm for obtaining the pupil center point with the eye image, which includes performing the circle detection algorithm for detecting initial pupil center point at step S104, and performing local binarization scheme for detecting the accurate a pupil center point based on the initial pupil center point at step S105. Therefore the gaze position tracking apparatus obtains the pupil center point.

The gaze position tracking apparatus points the user's gaze position on the monitor 300 by mapping the obtained user's pupil center point on the monitor plane through the predetermined transform function such as the linear interpolation transform function, the geometric transform function, and the cross ration transform function at step S106.

As described above, the gaze position tracking method and apparatus according to the certain embodiments of the present invention accurately detect the gaze position for a terminal having a display device using low cost equipment and performing simple algorithm. Therefore, the gaze position of a user can be obtained through the low cost system with the simple algorithm according to the present invention.

In the gaze position tracking method and apparatus according to the certain embodiments of the present invention, the eye image is obtained after reflecting the infrared image of eyes at 45°. Therefore, the high resolution eye image can be captured although the pupil moves in up and down directions.

In the gaze position tracking method and apparatus according to the certain embodiment of the present invention, the gaze position tracking apparatus includes the image capturing module connected to a terminal in the PnP manner and the image processing module embodied as software. Therefore, the gaze position tracking apparatus has comparability to all environments that can recognize the image processing module supporting the PnP.

What is claimed is:

1. A gaze position tracking apparatus for detecting a user's gaze position form a terminal having a display device, comprising:
an image capturing module for illuminating infrared rays to an user's eyes, reflecting an user's eye image illuminated by infrared rays (hereinafter, infrared eye image) at 45°, and capturing the 45° reflected user's eye image; and
an image processing module for obtaining a pupil center point of the infrared eye image by performing a predetermined algorithm, and mapping the pupil center point on a display plane of a display device through a predetermined transform function.

2. The gaze position tracking apparatus according to claim 1, wherein the image capturing module includes:
an infrared ray lighting unit for illuminating an infrared ray to the user's eyes;
an infrared ray reflector for reflecting the infrared eye image at 45°; and
an miniature camera for capturing the 45° reflected user's eye image.

3. The gaze position tracing apparatus according to claim 2, wherein the infrared lighting unit includes at least one of LED (light emitting diode), a halogen lamp, a xenon lamp, and an incandescent electric lamp.

4. The gaze position tracking apparatus according to claim 2, wherein the miniature camera includes:
a lens for receiving the 45° reflected user's eye image through the infrared reflector;
an image sensor formed of charge coupled device (CCD) or complementary metal-oxide semiconductor (CMOS) for receiving the user's eye image inputted to the lens; and
an infrared ray pass filter mounted on the entire surface of the lens or the image sensor for passing a infrared ray wavelength only.

5. The gaze position tracking apparatus according to claim 1, wherein the image capturing module is mounted at least one of glasses, goggles, a helmet, and a fixable supporting member.

6. The gaze position tracking apparatus according to claim 1, wherein the image capturing module is embodied in the terminal in software manner.

7. The gaze position tracking apparatus according to claim 2, wherein the image capturing module further includes an interface unit connected to the terminal in a PnP (plug and play) manner, supplying power provided from the terminal to the infrared ray lighting unit and the miniature camera, and providing every image frame captured through the miniature camera to the terminal.

8. The gaze position tracking apparatus according to claim 7, wherein the interface unit is connected to the terminal in at least one of a USB (universal serial bus) type, an analog type, a SD (secure digital) type, and a CD (compact disc) type.

9. The gaze position tracking apparatus according to claim 1, wherein the image processing module obtains the pupil center point from the eye image by performing at least one of a circle detection algorithm and a local binarization scheme, wherein the circle detection algorithm detects a pupil region included in the eye image by shifting a circle template to the eye image and obtains the pupil center point from the detected pupil region and the local binarization scheme performs binarization on predetermined region from the pupil region and detects the center of gravity of a dark region as the pupil center point.

10. The gaze position tracking apparatus according to claim 1, wherein the transform function is at least one of a linear interpolation transform function, a geometric transform function, and a cross ration transform function.

11. The gaze position tracking apparatus according to claim 1, wherein the image processing module calibrates a display plane position corresponding to a user's pupil center point by performing a user calibration process in a system initialization period, and performs a mapping process on the display plane for the every captured user's eye image.

12. The gaze position tracking apparatus according to claim 11, wherein the image processing module performs the user calibration process by calibrating the display plane position from an image of eyes gazing at a right upper corner and a left lower corner or from an image of eyes gazing at a right lower corner and a left upper corner using the linear interpolation transform function, or by calibrating the display plane position from images of eyes gazing at four corners of the display plane using the geometric transform function and the cross ration transform function.

13. A gaze position tracking method for detecting a user's gaze position for a terminal having a display device, comprising:
illuminating an infrared ray to a user's eyes gazing a display plane of the display device;
reflecting an eye image illuminated by infrared rays (hereinafter, infrared eye image) at 45° and capturing a 45° reflected eye image through a miniature camera;
obtaining a pupil center point of the eye image by performing the predetermined algorithm; and
mapping the pupil center point to the display plane using the predetermined transform function.

14. The gaze position tracking method according to claim 13, wherein in the step of illuminating the infrared ray, the user's eyes are illuminated using at least one of LED (light emitting diode), a halogen lamp, a xenon lamp, and an incandescent electric lamp.

15. The gaze position tracking detection method according to claim 13, wherein in the step of obtaining the user's eye image through the miniature camera, the 45° reflected infrared eye image is passed only by mounting an infrared ray passing filter on the entire surface of the miniature camera lens or an image sensor.

16. The gaze position tracking method according to claim 13, wherein in the step of capturing the 45° reflected user's eye image, the user's eye image is captured a miniature camera, an infrared ray lighting unit, and an infrared ray reflector mounted on at least one of glasses, goggles, a helmet, and a fixable supporting member.

17. The gaze position tracking method according to claim 13, wherein in the step of obtaining the pupil center point, the eye image captured through the miniature camera is provided to the terminal in a PnP manner, and the pupil center point is obtained through the predetermined algorithm equipped with the terminal.

18. The gaze position tracking method according to claim 17, wherein in the step of providing the eye image to a terminal in the PnP manner, the eye image is provided to the terminal in at least one of an USB type, an analog type, a SD type, and a CD type.

19. The gaze position tracking method according to claim 13, wherein the step of obtaining the pupil center point includes:
obtaining the pupil center point from the eye image by performing at least one of a circle detection algorithm and a local binarization scheme, wherein the circle detection algorithm detects a pupil region included in the eye image by shifting a circle template to the eye image and obtains the pupil center point from the detected pupil region and the local binarization scheme performs binarization on predetermined region from the pupil region and detects the center of gravity of a dark region as the pupil center point.

20. The gaze position tracking method according to claim 13, wherein in the step for mapping the pupil center point on a display plane, the pupil center point is mapped to the display plane through at least one of a linear interpolation transform function, a geometric transform function, and a cross ration transform function.

21. The gaze position tracking method according to claim 13, further comprising a step of calibrating a display plane position corresponding a user's pupil center point by performing a user calibration process in a system initialization period.

22. The gaze position tracking method according to claim 21, wherein in the step of calibrating the display plane position corresponding the user's pupil center point, the display plane position is calibrated from an image of eyes gazing at a right upper corner and a left lower corner or from an images of eyes gazing at a right lower corner and a left upper corner using the linear interpolation transform function, or the display plane position is calibrated from images of eyes gazing at four corners of the display plane using the geometric transform function and the cross ration transform function.
